(19) United States
(12) Patent Application Publication
(10) Pub. No.: US 2006/0247802 A1
(43) Pub. Date: Nov. 2, 2006

(54) Information encoding and decoding

(75) Inventors: Antti Takaluoma, Olulu (FI); Heikki Huomo, Oulu (FI); Jarno Vehmas, Saarenkyla (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Avantone Oy

(21) Appl. No.: 11/109,002

(22) Filed: Apr. 19, 2005

(51) Int. Cl. G05B 19/18

(52) U.S. Cl. 700/59

(57) ABSTRACT

The invention relates to encoding onto and decoding information from a printing surface. In an encoding process, data fragments of an information entity are incorporated into physical code fragments embodied by electrically readable ink patterns onto the printing surface in a printing process. The physical code fragments are distributed into a coordinate space determined by the printing surface such that each data fragment occurs repetitively in the coordinate space, thus providing redundant representation of information on the printing surface. In a decoding process, the electrically readable ink patterns are detected and converted to physical code fragments. The data fragments are extracted from the physical code fragments, and the data fragments are combined in order to form the information entity.

The invention relates to a method of encoding information in a data system, a method of encoding information on a printing surface, a product produced according to a process, a method of decoding information, an electric device, and to computer program products.

### BACKGROUND OF INVENTION

Optical bar codes provide a widely used information delivery method, which requires a remote reading from a printing surface, such as a printed matter. An optical bar code typically comprises a sequence of printed bars, whose width and location in the sequence define the information contents of the optical bar code.

The reading of optical bar codes, however, is prone to failure due to the sensitivity to the scanning action carried out by the user of a scanner and/or defects in the printing surface. Therefore, it is useful to consider alternatives for optical bar codes.

### BRIEF SUMMARY OF THE INVENTION

An object of the invention is to provide improved techniques for decoding and encoding information. According to a first aspect of the invention, there is provided a method of encoding information in a data system, the method comprising: incorporating data fragments of an information entity into physical code fragments, each data fragment being incorporated into at least one physical code fragment, each physical code fragment to be embodied by an electrically readable ink pattern disposed onto a printing surface; and distributing the physical code fragments into a coordinate space determined by the printing surface, at least one data fragment occurring repetitively in the coordinate space.

According to a second aspect of the invention, there is provided a computer program product embodied on a computer readable distribution medium, the computer program product for encoding a computer program of instructions for executing a computer process for encoding information, the process comprising: incorporating data fragments of an information entity into physical code fragments, each data fragment being incorporated into at least one physical code fragment, each physical code fragment to be embodied by an electrically readable ink pattern disposed onto a printing surface; and distributing the physical code fragments into a coordinate space determined by the printing surface, at least one data fragment occurring repetitively in the coordinate space.

According to a third aspect of the invention, there is provided a method of encoding information on a printing surface, the method comprising disposing electrically readable ink patterns onto a printing surface, each electrically readable ink pattern embodying a physical code fragment which incorporates at least one data fragment of an information entity, at least one data fragment occurring repetitively in the electrically readable ink patterns.

According to a fourth aspect of the invention, there is provided a product produced according to a process, the process comprising disposing electrically readable ink patterns onto a printing surface, each electrically readable ink pattern embodying a physical code fragment which incorporates at least one data fragment of an information entity, at least one data fragment occurring repetitively in the electrically readable ink patterns.

According to a fifth aspect of the invention, there is provided a method of decoding information, the method comprising: detecting electrically readable ink patterns from a printing surface, each electrically readable ink pattern embodying a physical code fragment which incorporates at least one data fragment of an information entity; converting the electrically readable ink patterns into physical code fragments; extracting data fragments from the physical code fragments; and combining the data fragments in order to form the information entity.

According to a sixth aspect of the invention, there is provided an electric device comprising: a detecting unit for detecting electrically readable ink patterns from a printing surface, each electrically readable ink pattern embodying a physical code fragment which incorporates at least one data fragment of an information entity; a converter unit for converting the electrically readable ink patterns into physical code fragments; an extracting unit for extracting data fragments from the physical code fragments; and a combiner for combining the data fragments in order to form the information entity.

According to a seventh aspect of the invention, there is provided a computer program product embodied on a computer readable distribution medium, the computer program product for encoding a computer program of instructions for executing a computer process for decoding information, the computer process comprising: controlling a process of detecting electrically readable ink patterns from a printing surface, each electrically readable ink pattern embodying a physical code fragment which incorporates at least one data fragment of an information entity; converting the electrically readable ink patterns into physical code fragments; extracting data fragments from the physical code fragments; and combining the data fragments in order to form the information entity.

The invention provides several advantages. The invention provides redundant representation of an information entity on a printing surface, thus enabling a random-like reading process to be used for reading the information.

### BRIEF DESCRIPTION OF THE DRAWINGS

In the following, the invention will be described in greater detail with reference to embodiments and the accompanying drawings, in which

FIG. 1 shows an example of structure of a graphical system;

FIG. 2 illustrates an example of a printing surface in accordance with an embodiment of the invention;

FIG. 3 shows a first example of a data structure in accordance with an embodiment of the invention;

FIG. 4 shows a second example of a data structure in accordance with an embodiment of the invention;

FIG. 5 shows a third example of a data structure in accordance with an embodiment of the invention;

FIG. 6 shows another example of a data structure in accordance with an embodiment of the invention;

FIG. 7 shows an example of a structure of an electric device in accordance with an embodiment of the invention;

FIG. 8 shows a first flow chart illustrating the embodiments in accordance with embodiments of the invention;

FIG. 9 shows a second flow chart illustrating methodology in accordance with embodiments of the invention;

FIG. 10 shows a third flow chart illustrating methodology in accordance with embodiments of the invention; and

FIG. 11 shows another flow chart illustrating methodology in accordance with embodiments of the invention.

### DETAILED DESCRIPTION OF THE INVENTION

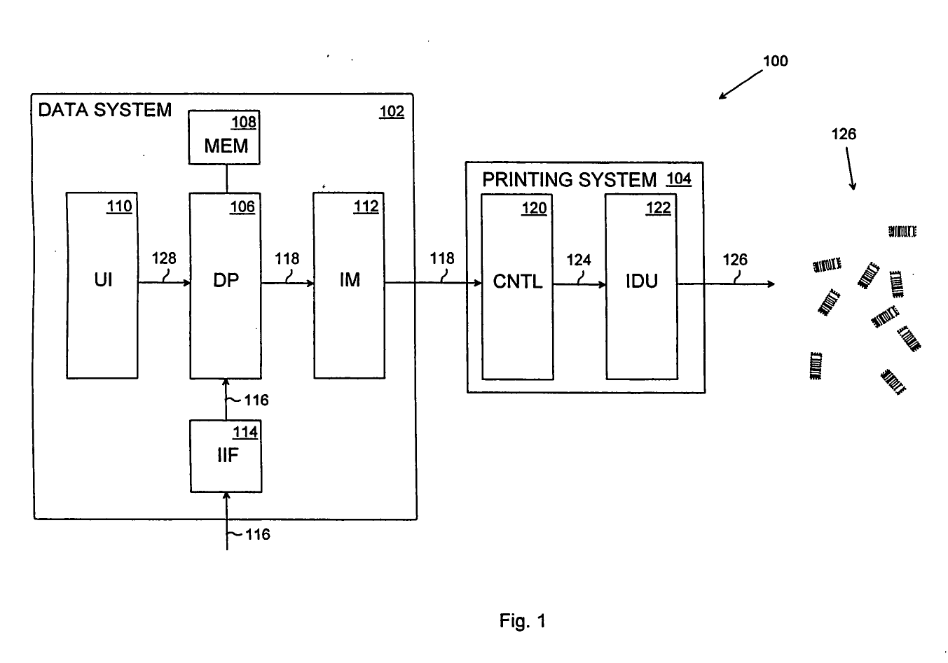

With reference to FIG. 1, examine an example of a graphical system 100 comprising a data system 102 and a printing system 104 connectable to the data system 102.

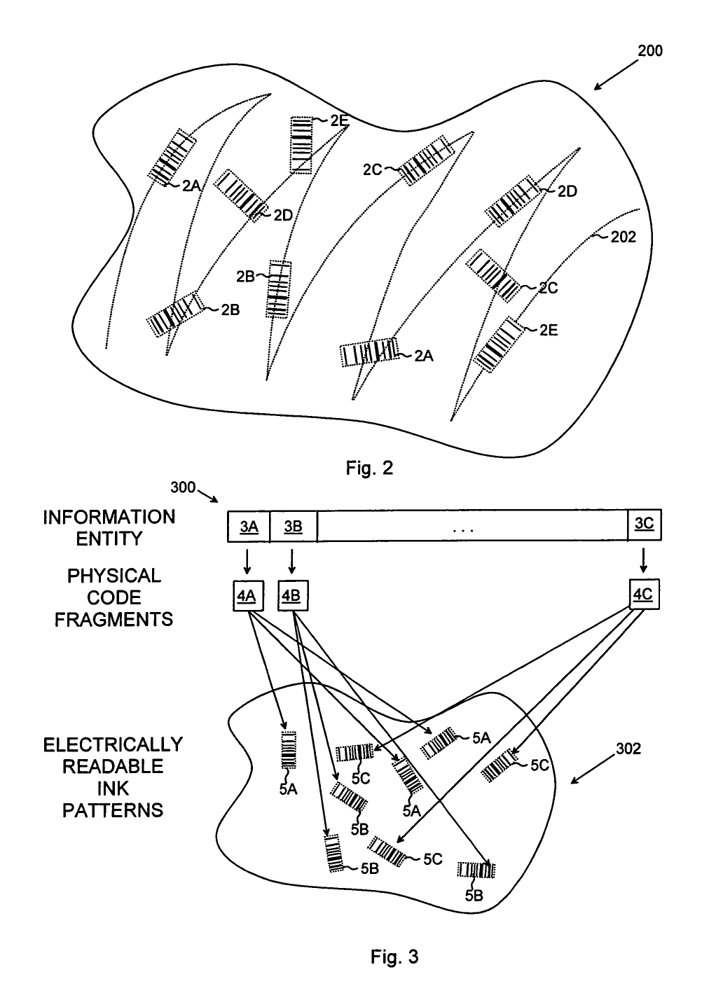

FIG. 2 shows an example of a printing surface 200 onto which electrically readable ink patterns 2A, 2B, 2C, 2D, 2E have been disposed. A dotted line illustrates a trajectory 202 of a reading device, which is used for recording the electrically readable ink patterns 2A to 2E.

The data system 100 comprises a digital processor (DP) 106 for executing computer processes according to coded instructions stored in a memory unit (MEM) 108 connected to the digital processor 106. The data system 102 may be a personal computer, for example.

The memory unit 108 may further include a database that contains information relating to the printing process. The database may include information on different types of electrically readable inks and information on different printing techniques.

The data system 102 typically provides a design tool for designing the physical layout of a group of electrically readable ink patterns 2A to 2E to be disposed onto the printing surface 200. The physical layout may be incorporated into a data stream 118 outputted by the digital processor 106.

In the physical layout, data fragments of an information entity are incorporated into physical code fragments so that each data fragment is incorporated into at least one physical code fragment. Each physical code fragment is embodied in a printing process by an electrically readable ink pattern 2A to 2E disposed onto a printing surface 200. Furthermore, the physical code fragments are distributed into a coordinate space determined by the printing surface 200 so that at least one data fragment occurs repetitively in the coordinate space. As a result, the electrically readable ink patterns provide redundant information on the data fragments, thus increasing the probability of obtaining each data fragment correctly from the printing surface in a reading process when the trajectory of the 202 of the reading device has random characteristics. The random characteristics may result from several factors, such as the personal usage behaviour of the user of the reading device.

A physical code fragment is an object, which typically includes information on the physical manifestation of a corresponding electrically readable ink pattern 2A to 2E. In an embodiment of the invention, the physical code fragment is a bitmap or other coded data stream representing the corresponding electrically readable ink pattern. The physical layout provides the information on the physical manifestation, location and/or orientation of the physical code fragments on the printing surface 200.

The printing system 104 disposes the electrically readable ink patterns 2A to 2E onto the printing surface 200 according to an output data stream 118 generated by the data system 102.

The data system 102 may further comprise a user interface (UI) 110 for providing communication means, such as an input device and an output device, for enabling communication between a user and the data system 102. The input device may comprise a keyboard, a keypad, and/or a mouse, for example. The output device may comprise a display and/or audio devices, for example.

The user interface 110 may be applied to provide control commands for controlling the data system 102. In an embodiment of the invention, the user interface 110 outputs an information entity data stream 128 which includes the information entity to be encoded onto the printing surface 200. In such a case, the user may input the information entity into the data system by using the input device.

In an embodiment of the invention, the data system 102 comprises an input interface (IIF) 114, such as a bus or a communication card, for acting as a gateway between an external information entity source and the data system 102. In this embodiment, the information entity is generated in the external source, such as a computer, mobile phone, camera, or any digital device capable of generating digital information relevant to be encoded onto the printing surface 200. In such case, the external bus 114 receives an external information data stream 116 from the external information entity source and inputs the external information data stream 116 into the digital processor 106 and/or into the memory unit 108. The external source may be connected to the data system via a communication network, such as the Internet and/or a wireless telecommunications system.

The information entity is typically a group of pieces of information, where the pieces constitute a logical entity and are associated with the same information entity. The pieces of information may or may not have a predetermined order.

The information entity may comprise at least one of the following: an audio file, a text file, a graphical file, a computer program. The invention is not, however, restricted to the given examples.

The information entity may be encoded in a standard data format, such as ASCII (American Standard Code for Information Interchange), PDF (Portable Document Format), JPEG (Joint Photographic Experts Group), MPEG (Moving Picture Experts Group), GIF (Graphics Interchange Format), WAV (Wave File), SMS(Short Message Service), MMS (Multimedia Message Service), Java applet, or any other standard format.

The data system 102 may further include an interface module (IM) 112 which acts as an interface between the data system 102 and the printing system 104. The interface module 112 may be a bus, a communication module, such as an Ethernet card, a removable data storage device, such as a removable hard drive, a compact disc, or a removable memory unit. The data system 102 may be integrated with the printing system 104 or the data system 102 may be physically separate from the printing system 104.

The printing system 104 typically comprises a disposing unit 122, which implements the physical disposing of the electrically readable ink patterns onto the printing surface 200. The disposing unit 122 may be connected to a disposing controller 120 connected to the disposing unit 122. The disposing controller 120 receives the output data stream 118 from the data system 102 and generates a disposing instruction signal 124 for the disposing unit 122. The disposing unit 122 outputs a printing product 126. The printing product 126 may be an object that includes the printing surface 200 onto which the electrically readable ink patterns 2A to 2E are disposed. In an embodiment of the invention, the printing product is a printout of the electrically readable ink patterns 2A to 2E as such. In such a case, the printing system 104 may be a movable printing device, which is brought into the proximity of the printing surface for printing. The printing surface may be a surface of a large object which cannot be fed into a printing device.

The disposing unit 122 may apply conventional printing techniques applied to a number of printing surfaces. The printing technique may be, for example, gravure printing, flexo printing, offset printing, screen printing, engraving, laser printing, inkjet or any other suitable printing process. The disposing unit 122 may be a part of a printing device used in a home environment, or the disposing unit 122 may be a part of a large press system which presses a great amount of print products, such as newspapers, magazines, books, consumer packs, wraps, or other print products.

The electrically readable ink is typically electrically active ink whose electrical properties are known and which is electrically readable from the printing surface 200. Such electrical properties include, for example, resistivity and/or conductivity of the ink, uniformity of conductivity and signal transition time up or down when a detector moves from one information element to another information element of an electrically readable ink pattern 2A to 2E. A maximum square resistance (Rsq) of the electrically readable ink is typically of the order of 100 kΩ/sq in order for the reading to succeed. Resistance non-uniformity between conductive areas of an electrically readable ink pattern 2A to 2E should not exceed 30% in order to ensure decoding robustness. The required transition time depends on the resolution. As an example, when the width of the smallest code element is 300 micrometers, the signal amplitude typically rises to 90% of its maximum value within a distance of 60 micrometers in the movement of the detector.

The electrically readable ink may be for example carbon graphite ink sold under the trade name Precisia and manufactured by Flint Ink.

In an embodiment of the invention, the electrically readable ink is optically inactive, which results in a low optical visibility or invisibility of the electrically readable ink patterns 2A to 2E from the printing surface 200. In such a case, the electrically readable ink patterns 2A to 2E have a low visibility or invisibility to human eye. The printing surface 200 may also contain optically visible prints which may overlap the electrically readable ink patterns 2A to 2E.

An electrically readable ink pattern 2A to 2E comprises a code which is defined by a physical code fragment. The code may be a one-dimensional and/or a two-dimensional bar code. The bar code may also be a round bar code.

The code may consist of lines of different widths and spaces, different widths between the lines, or spots of different sizes and spaces of different sizes between the spots, or areas of different sizes and spaces of different sizes between the areas. The code may employ binary symbols, or more advanced symbol schemes.

In an embodiment of the invention, the physical code fragments incorporating the first data fragment includes a start mark. In the reading process, the start mark indicates that the first data fragment has been read.

In an embodiment of the invention, the physical code fragments incorporating the last data fragment included a stop mark. In the reading process, the stop mark indicates that the last data fragment has been read.

In an embodiment of the invention, the physical code fragment is associated with readability information which characterizes the probability of obtaining a data fragment correctly from the electrically readable ink pattern 2A to 2E embodying the physical code fragment. The readability information may take into account various factors, such as printing density, data density in the physical code fragment, estimated quality of the printing result, estimated reading behaviour of an average person using the reading device and/or characteristics of the printing surface 200. The readability information may be obtained from the memory unit 108 of the data system 102 or the readability information may be generated in the data system 102.

The physical code fragments may be distributed into the coordinate space according to the readability information. In an embodiment, physical code fragments with high readability may be distributed in locations of the printing surface 200 where the probability of pointing the reading device is low. Edges of the printing surface 200 are typically such locations. Furthermore, the frequency of occurrence of physical code fragments with high readability may be lower than that of those with low readability. This results in a redundancy of a presentation of the information entity on the printing surface 200.

On the contrary, physical code fragments with low readability may be located in locations of the printing surface 200 where the probability of pointing the reading device is high. This increases the probability of pointing at the electrically readable ink pattern corresponding to the physical code fragment.

With reference to FIG. 3, examine an embodiment of a data structure and an encoding scheme of an information entity 300.

The information entity 300 is divided into data fragments 3A, 3B, 3C, which include information elements, such as binary codes, ASCII codes or other codes.

Each data fragment 3A to 3C is incorporated into at least one physical code fragment 4A, 4B, 4C. In this embodiment, each data fragment 3A to 3C is incorporated into a physical code fragment 4A to 4C, and each physical code fragment 4A to 4C includes one data fragment 3A to 3C as its information contents.

The physical code fragments 4A to 4C are embodied on electrically readable ink patterns 5A to 5C printed on the printing surface 302. In this embodiment, an electrically readable ink pattern 5A to 5C embodying each physical code fragment 4A to 4C occurs several times on the printing surface 302. As a result, each data fragment 3A to 3B occurs repetitively in the electrically readable ink patterns, and the probability of obtaining a data fragment correctly in random-like reading is increased.

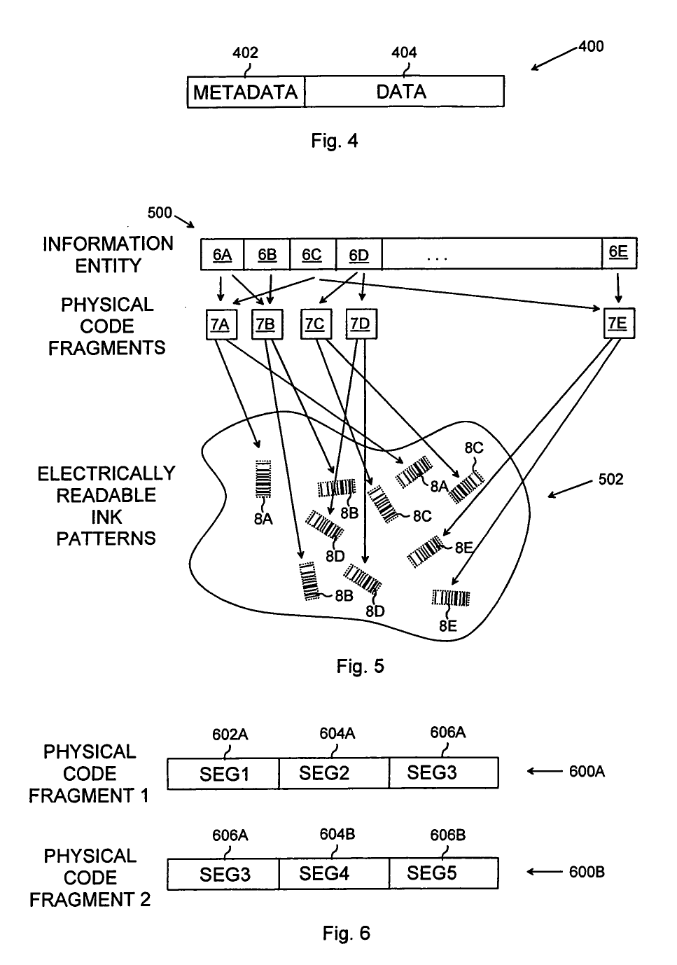

With reference to FIG. 4, a data structure of a physical code fragment 400 is illustrated. The physical code fragment 400 may include a metadata field 402 and a data field 404.

The data field 404 contains data associated with the data fragment. The data of the data field 404 may be encoded with the aforementioned standard format.

The metadata field 402 contains metadata, which is typically used for characterizing the contents of the data fragment 3A to 3C and for defining, for example, the location of the data fragment 3A to 3C in the information entity 300. The metadata may contain a data fragment-specific index, which indicates the location of the data fragment in the information entity 300.

The metadata may also comprise an Internet address or other addresses accessible, for example, over telecommunication networks where a driver required for decoding the physical code fragment 400 may be found for a reading device.

With reference to FIG. 5, an information entity 500 is divided into data fragments 6A to 6E. Physical code fragments 7A to 7E are also shown.

A first group of data fragments 6A, 6C is incorporated into a first physical code fragment 7A and a second group of data fragments 6A, 6B is incorporated into a second physical code fragment 7B. According to this embodiment, the first group and the second group share at least one data fragment 6A. A similar coding scheme may be applied to data fragments 6D and 6E such that at least one data fragment is common to at least two physical code fragments 7A to 7E.

The sharing of data fragments may be implemented by selecting bit streams overlapping each other from the information entity 500. Each bit stream represents a group, such as the first group and the second group. The overlapping portion of the bit streams represents the data fragment being shared between the first group and the second group. With this procedure, an entire information entity may be divided into overlapping portions, and the overlaps of successive bit streams may be used to reconstruct the information entity in a decoding procedure. In this case, the metadata may not be required.

The physical code fragments 7A to 7E are embodied by electrically readable ink patterns 8A to 8E. The repetition of a data fragment 6A to 6E results from the decoding of the data fragments 6A to 6E into the physical code fragments 7A to 7E as such. A further redundancy between the physical fragments 7A to 7E may be obtained by repeating the occurrence of electrically readable ink patterns 8A to 8E.

In an embodiment of the invention, the data fragments 6A to 6E are decoded with a semi-random-like code into the physical code fragments 7A to 7E. The use of the semi-random-like code results in random-like symbol sequences in the physical code fragments 7A to 7E, and reduces the occurrence of similar symbol sequences in the physical code fragments 7A to 7E. As a result, the probability of finding the correct overlap between the contents of two physical code fragments 7A to 7E is increased.

In an embodiment of the invention, the physical code fragments 4A to 4C, 6A to 6E are distributed randomly into the coordinate space, thus resulting in a random distribution of the corresponding electrically readable ink patterns 5A to 5C, 8A to 8E on the printing surface 302, 502. The direction of the physical code fragment 4A to 4C, 6A to 6E may also be random.

In an embodiment of the invention, the data fragments 3A to 3C, 6A to 6E are incorporated into physical code fragments 4A to 4C, 7A to 7E of different data storage capacity. The physical code fragments 4A to 4C, 7A to 7E may be distributed into the coordinate space according to the data storage capacity. For example, physical code fragments 4A to 4C, 7A to 7E with high data storage capacity may be located in locations of the coordinate space where the probability of pointing the reading device is high. Physical code fragments 4A to 4C, 7A to 7E with low data storage capacity may be located in locations of the coordinate space where the probability of pointing the reading device is low.

With reference to FIG. 6, examples of the contents of physical code fragments 600A, 600B are shown. A first physical code fragment 600A includes data fragments 602A, 604A, 606A, while a second physical code fragment 600B includes data fragments 606A, 604B, 606B. In such a case, the data fragment 606A is shared by the first physical code fragment 600A and the second physical code fragment 600B.

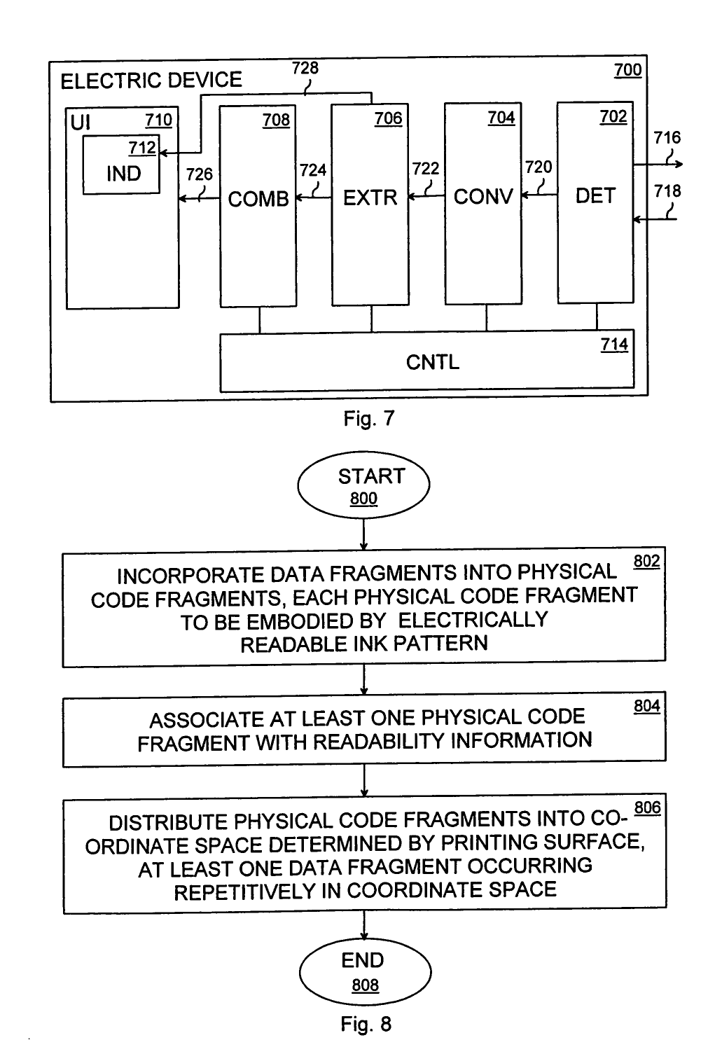

With reference to FIG. 7, examine an example of a structure of an electric device 700 which may be used as a reading device for reading electrically readable ink patterns 2A to 2E. The electric device 700 may be a reader dedicated to reading electrically readable ink patterns. In an embodiment of the invention, the electric device 700 is integrated into a mobile phone, a PDA (Personal Digital Assistant) and/or a laptop.

The electric device 700 comprises a computer implemented with a digital processor and memory.

The electric device 700 is typically a handheld device, which is used as a scanner for recording the electrically readable ink patterns 2A to 2E from the printing surface 200. An example of a random-like reading trajectory 202 is shown in FIG. 2.

The electric device 700 comprises a detecting unit (DET) 702, a converter unit (CONV) 704 connected to the detecting unit 702, an extracting unit (EXTR) 706 connected to the converter unit 704 and a combiner (COMB) 708 connected to the converter unit 704. FIG. 7 further shows a user interface 710 and a controller 714.

The detecting unit 702 detects the electrically readable ink patterns 2A to 2E from the printing surface 200 by using an electrical reading, such as capacitive reading. The detecting unit 702 may direct a probe signal 716 to the printing surface 200, which probe signal 716 results in a response signal 718 to be generated by the electrically readable ink patterns 2A to 2E.

In an embodiment of the invention, the detecting unit 702 is a capacitive reader whose details are known to one skilled in the art. The detecting unit 702 may be implemented with an ASIC (Application Specific Integrated Circuit) and software, for example.

The detecting unit 702 may be a reading module disclosed in a co-pending U.S. patent application having U.S. Ser. No. 11/015,647, filed on Dec. 20, 2004 and entitled “A sensor head of a code reader”, which is hereby incorporated by reference.

In an embodiment of the invention, the detecting unit 702 is a reading module disclosed in a co-pending U.S. patent application having U.S. Ser. No. 11/024,035, filed on Dec. 29, 2004 and entitled “Code reader”, which is also hereby incorporated by reference.

The detecting unit 702 inputs a measurement signal 720 representing the electric characteristics of the electrically readable ink patterns 2A to 2E. The signal 720 may represent signal levels generated from the response signal 718, for example.

The converter unit 704 receives the measurement signal 720 and converts the measurement signal 720 into a physical code fragment. The converter unit 704 may analyze the physical characteristics of the electrically readable ink patterns 2A to 2E and generate a physical code fragment which matches the electrically readable ink pattern 2A to 2E. The converter unit 704 may be implemented with a computer and software. Furthermore, the converter unit 704 may include ASICs.

In an embodiment of the invention, the electric device 700 indicates the user about a successful reading of an electrically readable ink pattern 2A to 2E. The converter unit 704 may send a confirmation signal to the user interface 710 about the successful interpretation of an electrically readable ink pattern 2A to 2E. The user interface 710 may generate an acoustic or optical signal, for example, on the basis of the conformation signal.

The extracting unit 706 receives an information signal 722 from the converter unit and extracts the data fragments from the physical code fragments. The information signal 722 carries information on the physical code fragments.

The extracting unit 706 may decode a code, such as a bar code, represented by the physical code fragment and generate data fragments from the code. The extracting unit 706 may be implemented with computer of the electric device and software.

The extracting unit 706 outputs a data fragment signal 724 into the combiner 708. The data fragment signal 724 carries information on the data fragments extracted by the extracting unit 706.

The combiner 708 combines the data fragments and forms an information entity once it has obtained required data fragments of the information entity. The combiner 708 may read metadata associated with the data fragments and combine the data fragments by using indices.

In an embodiment of the invention, the combiner determines a correspondence between the contents of physical code fragments and combines the data fragments incorporated on the basis of the correspondence. The correspondence may arise from a case similar to that shown in FIG. 6, where a data fragment 606A is common to two physical code fragments 600A, 600B. The combiner 708 may scan for similar data fragments and join data fragments on the basis of an overlap. The correspondence may be determined by, for example, calculating a correlation between the contents of physical code fragments 600A, 600B.

The combiner 708 may input a signal 726 carrying each decoded data fragment, portions of the information entity, and/or the entire information entity to the user interface for graphical and/or numeric display.

In an embodiment of the invention, the electric device 700 comprises an indication unit 712, which indicates to the user about a successful decoding of an electrically readable ink pattern 2A to 2E. The extracting unit 706 may generate an indication signal 728 as a result of a successful decoding of an electrically readable ink pattern 2A to 2E and input the indication signal 728 to the indication unit 712. The indication unit 712 may generate an audio and/or an optical signal as an indication of the successful encoding. The user may change the location at which the detecting unit 702 is swept on the printing surface 200.

In an embodiment of the invention, the combiner 708 generates a completion indication signal as an indication of the completion of a reading process of the information entity and inputs the completion signal into the user interface 710. The indication unit 712 or other indication means may generate an audio and/or an optical signal as an indication of the completion of the reading process.

The combiner 708 may be implemented with a computer and software.

The electric device 700 may further comprise a controller 714, which typically controls the detecting unit 702 and other functional blocks 704 to 708 of the electric device. The controller 714 may control the ASIC of the detector 702.

With reference to FIGS. 8, 9, 10 and 11 methodology according to embodiments of the invention is illustrated with flow chart presentations.

With reference to FIG. 8, the method starts in 800.

In 802, data fragments 3A to 3C, 6A to 6E of an information entity 300, 500 are incorporated into physical code fragments 4A to 4C, 7A to 7E, each data fragment 3A to 3C, 6A to 6E being incorporated into at least one physical code fragment 4A to 4C, 7A to 7E, each physical code fragment 4A to 4C, 7A to 7E to be embodied by an electrically readable ink pattern 5A to 5C, 8A to 8E disposed onto a printing surface.

In an embodiment, a first group of data fragments is incorporated into a first physical code fragment and a second group of data fragments is incorporated into a second physical code fragment, the first group and the second group sharing at least one data fragment.

In an embodiment, data fragments 3A to 3C, 6A to 6E of an information entity 300, 500 are incorporated into physical code fragments 4A to 4C, 7A to 7E of different data storage capacity.

In 804, according to an embodiment, at least one physical code fragment 4A to 4C, 7A to 7E is associated with readability information characterizing the probability of obtaining the at least one data fragment 3A to 3C, 6A to 6E correctly from the electrically readable ink pattern 5A to 5C, 8A to 8E embodying the physical code fragment 4A to 4C, 7A to 7E.

In 806, the physical code fragments 4A to 4C, 7A to 7E are distributed into the coordinate space determined by the printing surface, at least one data fragment 3A to 3C, 6A to 6E occurring repetitively in the coordinate space.

In an embodiment of the invention, the physical code fragments 4A to 4C, 7A to 7E are distributed into the coordinate space according to the readability information.

In 808, the method ends.

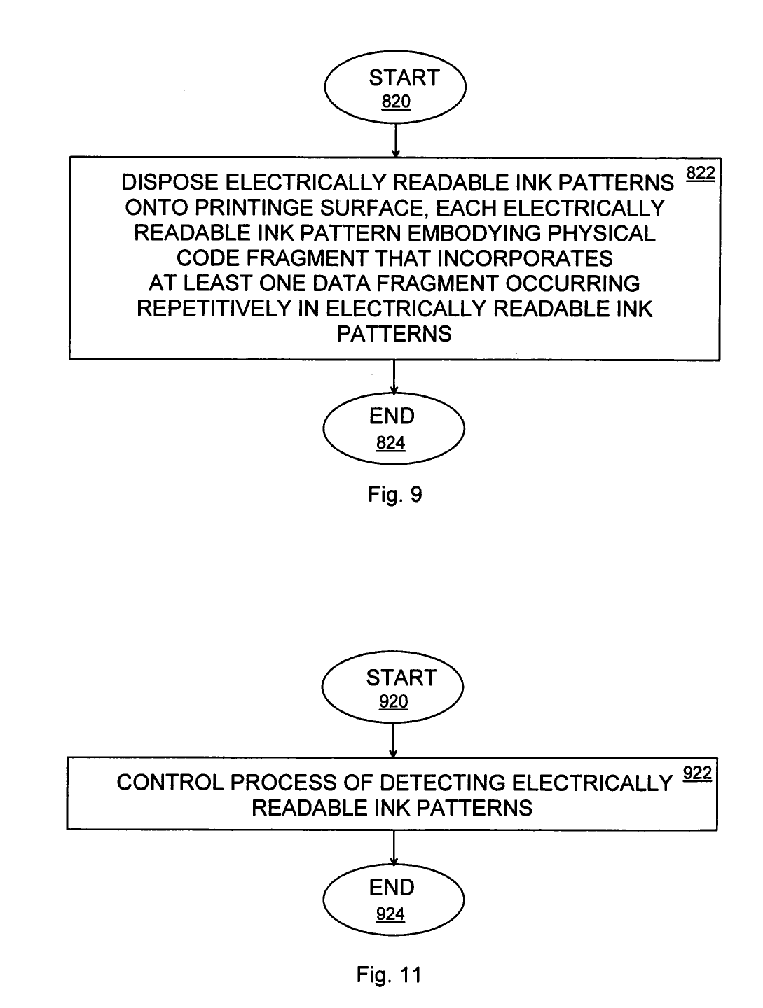

With reference to FIG. 9, the method starts in 820.

In 822, electrically readable ink patterns 5A to 5C, 8A to 8E are disposed onto a printing surface 302, 502, each electrically readable ink pattern 5A to 5C, 8A to 8E embodying a physical code fragment 4A to 4C, 7A to 7E which incorporates at least one data fragment 3A to 3C, 6A to 6E of an information entity 300, 500, at least one data fragment 3A to 3C, 6A to 6E occurring repetitively in the electrically readable ink patterns 5A to 5C, 8A to 8E.

In an embodiment of the invention, a first electrically readable ink pattern embodies a first physical code fragment which incorporates a first group of data fragments of an information entity 300, 500 and a second ink pattern embodies a second physical code fragment that incorporates a second group of data fragments of the information entity 300, 500, and the first group and the second group include at least one common data fragment.

In an embodiment of the invention, an electrically readable ink pattern 5A to 5C, 8A to 8E is disposed onto the printing surface 302, 502 according to readability information characterizing the probability of obtaining the at least one data fragment 3A to 3C, 6A to 6E correctly from the electrically readable ink pattern 5A to 5C, 8A to 8E embodying the physical code fragment 4A to 4C, 7A to 7E.

In an embodiment of the invention, the electrically readable ink patterns 5A to 5C, 8A to 8E are disposed onto the printing surface 302, 502 according to the data storage capacity of the electrically readable ink pattern 5A to 5C, 8A to 8E.

In 824, the method ends.

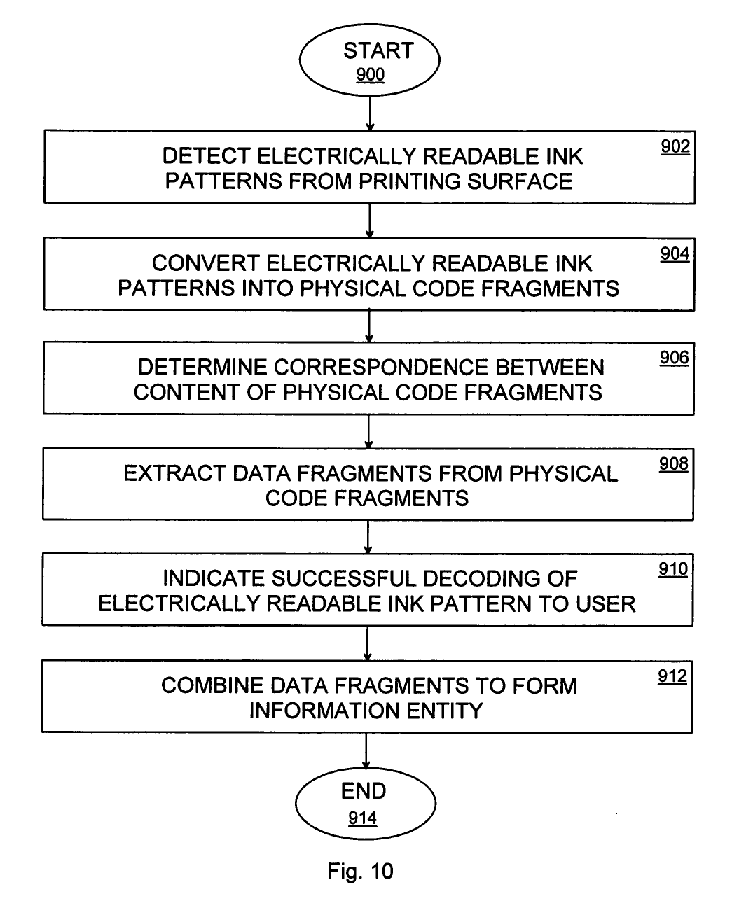

With reference to FIG. 10, the method starts in 900.

In 902, electrically readable ink patterns 5A to 5C, 8A to 8E are detected from a printing surface 302, 502, each electrically readable ink pattern 5A to 5C, 8A to 8E embodying a physical code fragment 4A to 4C, 7A to 7E that incorporates at least one data fragment 3A to 3C, 6A to 6E of an information entity 300, 500.

In 904 the electrically readable ink patterns 5A to 5C, 8A to 8E are converted into the physical code fragments 4A to 4C, 7A to 7E.

In 906, according to an embodiment, a correspondence between the contents of physical code fragments 4A to 4C, 7A to 7E is determined.

In 908, data fragments 3A to 3C, 6A to 6E are extracted from the physical code fragments 4A to 4C, 7A to 7E.

In 910, according to an embodiment, a successful decoding of an electrically readable ink pattern 5A to 5C, 8A to 8E is indicated to the user of the electric device 700.

In 912, the data fragments 3A to 3C, 6A to 6E are combined in order to form the information entity 300, 500.

In an embodiment of the invention, the data fragments 3A to 3C, 6A to 6E incorporated by the physical code fragments 4A to 4C, 7A to 7E are combined on the basis of the correspondence.

In 914, the method ends.

With reference to FIG. 11, the method starts in 920.

In 922, a process of detecting electrically readable ink patterns 5A to 5C, 8A to 8E from a printing surface 302, 502 is controlled, each electrically readable ink pattern 5A to 5C, 8A to 8E embodying a physical code fragment 4A to 4C, 7A to 7E which incorporates at least one data fragment 3A to 3C, 6A to 6E of an information entity 300, 500.

In 924, the method ends.

An aspect of the invention provides a computer program product embodied on a computer readable distribution medium, the computer program product for encoding a computer program of instructions for executing a computer process for encoding information. Embodiments of the computer program product are described in conjunction with FIG. 8. The computer program may be executed in the digital processor 106 of the data system 102 and stored in the memory unit 108 of FIG. 1, for example.

In an aspect of the invention, the invention provides a computer program product embodied on a computer readable distribution medium, the computer program product for encoding a computer program of instructions for executing a computer process for decoding information. Embodiments of the computer program product are described in conjunction with FIGS. 10 and 11. The computer program may be executed in the computer of the electric device 700.

The computer program may be stored on a computer program distribution medium readable by a computer or a processor. The computer program medium may be, for example, but not limited thereto, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to an example according to the accompanying drawings, it is clear that the invention is not restricted thereto but it can be modified in several ways within the scope of the appended claims.

That which is claimed:

1. A method of encoding information in a data system, the method comprising:
incorporating data fragments of an information entity into physical code fragments, each data fragment being incorporated into at least one physical code fragment, each physical code fragment to be embodied by an electrically readable ink pattern disposed onto a printing surface; and
distributing the physical code fragments into a coordinate space determined by the printing surface, at least one data fragment occurring repetitively in the coordinate space.

2. A method of claim 1, further comprising incorporating a first group of data fragments into a first physical code fragment and a second group of data fragments into a second physical code fragment, the first group and the second group sharing at least one data fragment.

3. A method of claim 1, further comprising:
associating at least one physical code fragment with readability information characterizing a probability of obtaining the at least one data fragment correctly from the electrically readable ink pattern embodying the physical code fragment; and
distributing the physical code fragments into the coordinate space according to the readability information.

4. A method of claim 1, further comprising:
incorporating data fragments of an information entity into physical code fragments of different data storage capacity; and
distributing the physical code fragments into the coordinate space according to the data storage capacity.

5. A computer program product embodied on a computer readable distribution medium, the computer program product for encoding a computer program of instructions for executing a computer process for encoding information, the computer process comprising:
incorporating data fragments of an information entity into physical code fragments, each data fragment being incorporated into at least one physical code fragment, each physical code fragment to be embodied by an electrically readable ink pattern disposed onto a printing surface; and
distributing the physical code fragments into a coordinate space determined by the printing surface, at least one data fragment occurring repetitively in the coordinate space.

6. A computer program product of claim 5, wherein the computer process further comprises incorporating a first group of data fragments into a first physical code fragment and a second group of data fragments into a second physical code fragment, the first group and the second group sharing at least one data fragment.

7. A computer program product of claim 5, wherein the computer process further comprises:
associating at least one physical code fragment with readability information characterizing a probability of obtaining the at least one data fragment correctly from the electrically readable ink pattern embodying the physical code fragment; and
distributing the physical code fragments into the coordinate space according to the readability information.

8. A computer program product of claim 5, wherein the computer process further comprises:
incorporating data fragments of an information entity into physical code fragments of different data storage capacity; and
distributing the physical code fragments into the coordinate space according to the data storage capacity.

9. A method of encoding information on a printing surface, comprising disposing electrically readable ink patterns onto a printing surface, each electrically readable ink pattern embodying a physical code fragment which incorporates at least one data fragment of an information entity, at least one data fragment occurring repetitively in the electrically readable ink patterns.

10. A method of claim 9, further comprising disposing the electrically readable ink patterns onto the printing surface, a first electrically readable ink pattern embodying a first physical code fragment which incorporates a first group of data fragments of an information entity and a second ink pattern embodying a second physical code fragment which incorporates a second group of data fragments of the information entity, the first group and the second group sharing at least one data fragment.

11. A method of claim 9, further comprising disposing an electrically readable ink pattern onto the printing surface according to readability information characterizing a probability of obtaining the at least one data fragment correctly from the electrically readable ink pattern embodying the physical code fragment.

12. A method of claim 9, further comprising disposing an electrically readable ink pattern onto the printing surface according to the data storage capacity of the electrically readable ink pattern.

13. A product produced according to a process, the process comprising disposing electrically readable ink patterns onto a printing surface, each electrically readable ink pattern embodying a physical code fragment which incorporates at least one data fragment of an information entity, at least one data fragment occurring repetitively in the electrically readable ink patterns.

14. A product of claim 13, wherein the process further comprises disposing the electrically readable ink patterns onto the printing surface, a first electrically readable ink pattern embodying a first physical code fragment which incorporates a first group of data fragments of an information entity and a second ink pattern embodying a second physical code fragment which incorporates a second group of data fragments of the information entity, the first group and the second group sharing at least one data fragment.

15. A product of claim 13, wherein the process further comprises disposing an electrically readable ink pattern onto the printing surface according to readability information characterizing a probability of obtaining the at least one data fragment correctly from the electrically readable ink pattern embodying the physical code fragment.

16. A product of claim 13, wherein the process further comprises disposing an electrically readable ink pattern onto the printing surface according to the data storage capacity of the electrically readable ink pattern.

17. A method of decoding information, comprising:
detecting electrically readable ink patterns from a printing surface, each electrically readable ink pattern embodying a physical code fragment which incorporates at least one data fragment of an information entity;
converting the electrically readable ink patterns into physical code fragments;
extracting data fragments from the physical code fragments; and
combining the data fragments in order to form the information entity.

18. The method of claim 17, further comprising:
determining a correspondence between contents of the physical code fragments; and
combining the data fragments incorporated by the physical code fragments on the basis of the correspondence.

19. The method of claim 17, further comprising indicating a successful decoding of an electrically readable ink pattern to the user of the electric device.

20. An electric device, comprising:
a detecting unit for detecting electrically readable ink patterns from a printing surface, each electrically readable ink pattern embodying a physical code fragment which incorporates at least one data fragment of an information entity;
a converter unit for converting the electrically readable ink patterns into physical code fragments;
an extracting unit for extracting data fragments from the physical code fragments; and
a combiner for combining the data fragments in order to form the information entity.

21. The electric device according to claim 20, wherein the combiner is configured to determine a correspondence between contents of the physical code fragments; and
wherein the combiner is configured to combine the data fragments incorporated by the physical code fragments on the basis of the correspondence.

22. The electric device according to claim 20 further comprising an indication unit for indicating a successful decoding of an electrically readable ink pattern to the user of the electric device.

23. A computer program product embodied on a computer readable distribution medium, the computer program product for encoding a computer program of instructions for executing a computer process for decoding information, the computer process comprising:
controlling a process of detecting electrically readable ink patterns from a printing surface, each electrically readable ink pattern embodying a physical code fragment which incorporates at least one data fragment of an information entity;
converting the electrically readable ink patterns into physical code fragments;
extracting data fragments from the physical code fragments; and
combining the data fragments in order to form the information entity.

24. The computer program product of claim 23, wherein the computer process further comprises:
determining a correspondence between contents of the physical code fragments; and
combining the data fragments incorporated by the physical code fragments on the basis of the correspondence.

25. The computer program product of claim 23, wherein the computer process further comprises indicating a successful decoding of an electrically readable ink pattern to the user of an electric device.
